(19) United States
(12) Patent Application Publication
(10) Pub. No.: US 2013/0062524 A1
(43) Pub. Date: Mar. 14, 2013

(54) METHOD OF MEASURING CHARACTERISTICS OF SPECIMEN, AND APERTURE ARRAY STRUCTURE AND MEASURING DEVICE USED IN SAME

(71) Applicant: MURATA MANUFACTURING CO., LTD., Nagaokakyo-Shi (JP)

(72) Inventors: Kazuhiro Takigawa, Nagaokakyo-shi (JP); Seiji Kamba, Nagaokakyo-shi (JP); Takashi Kondo, Kyoto-fu (JP); Yuichi Ogawa, Kyoto-shi (JP)

(21) Appl. No.: 13/672,758

(22) Filed: Nov. 9, 2012

Related U.S. Application Data
(63) Continuation of application No. PCT/JP2011/053360, filed on Feb. 17, 2011.

(30) Foreign Application Priority Data
May 12, 2010 (JP) 2010-110306

(51) Int. Cl. G01N 21/59; G01N 22/00

(52) U.S. Cl. 250/358.1

(57) ABSTRACT

A method of measuring characteristics of a specimen by holding the specimen on an aperture array structure, which is formed of a flat plate and which includes at least two apertures penetrating therethrough in a direction perpendicular to a principal surface thereof; applying a linearly-polarized electromagnetic wave to the aperture array structure on which the specimen is held; and detecting a frequency characteristic of the electromagnetic wave having transmitted through the aperture array structure. The aperture array structure has a lattice structure in which the apertures are periodically arrayed at least in one direction in the principal surface of the aperture array structure, and a ratio (s/A) of a lattice spacing (s) of the aperture array structure to a thickness (A) of the specimen is 100 or less.

### CROSS REFERENCE TO RELATED APPLICATIONS

The present application is a continuation of International application No. PCT/JP2011/053360, filed Feb. 17, 2011, which claims priority to Japanese Patent Application No. 2010-110306, filed May 12, 2010, the entire contents of each of which are incorporated herein by reference.

### FIELD OF THE INVENTION

The present invention relates to a method of measuring characteristics of a specimen, and to an aperture array structure and a measuring device for use in the method. More particularly, the present invention relates to a method of holding a specimen on an aperture array structure, applying an electromagnetic wave to the aperture array structure on which the specimen is held, and detecting the electromagnetic wave having transmitted through the aperture array structure, thereby measuring characteristics of the specimen. The present invention further relates to an aperture array structure and a measuring device, which are used in the above-described method.

### BACKGROUND OF THE INVENTION

Hitherto, characteristics of substances have been analyzed by a measuring method of holding a specimen on an aperture array structure, applying an electromagnetic wave to the aperture array structure on which the specimen is held, and analyzing a transmittance spectrum of the electromagnetic wave, thereby measuring characteristics of the specimen. More specifically, there is, for example, a method of applying a terahertz wave to a metal mesh filter to which a protein, i.e., a protein, is attached, and analyzing a transmittance spectrum of the terahertz wave.

Patent Document 1 (Japanese Unexamined Patent Application Publication No. 2007-010366), Patent Document 2 (Japanese Unexamined Patent Application Publication No. 2007-163181), and Patent Document 3 (Japanese Unexamined Patent Application Publication No. 2008-185552) disclose a method of holding a specimen on an aperture array structure (e.g., a metal mesh) having aperture regions, applying an electromagnetic wave to the aperture array structure on which the specimen is held, and detecting the electromagnetic wave that has transmitted through the aperture array structure, thereby measuring the characteristics of the specimen based on change of a frequency characteristic, which change is attributable to the presence of the specimen.

In Patent Document 3, an electromagnetic wave projected toward the aperture array structure from an electromagnetic wave irradiation portion obliquely enters a plane including the aperture regions,

Among the above-mentioned Patent Documents, Patent Document 3 discloses a method of, with attention focused on a dip waveform that generates in a frequency characteristic of a measured value when the electromagnetic wave is applied to obliquely enter a principal surface of the aperture array structure, measuring the characteristics of the specimen based on change of the dip waveform, which change is attributable to the presence of the specimen. In Patent Document 3, the dip waveform is produced to appear near 1 to 3 THz (see FIGS. 7 to 9 of Patent Document 3).

### SUMMARY OF THE INVENTION

In the related-art measuring methods described above, when an amount of the specimen is very small, the change of the frequency characteristic is also small, thus giving rise to a difficulty in detecting the characteristics of the specimen. The reason resides in that a thickness of the specimen held on the aperture array structure is reduced and spreading of an electromagnetic field localized on the surface of the aperture array structure becomes too large relative to the thickness of the specimen, whereby the efficiency in terms of sensing technique degrades.

Accordingly, an object of the present invention is to provide not only a method of measuring characteristics of a specimen with high sensitivity and high efficiency even when an amount of the specimen is very small, but also an aperture array structure and a measuring device which are used in the above-described method.

The present invention provides a method of measuring characteristics of a specimen, the method comprising the steps of:

holding the specimen on an aperture array structure, which is formed of a flat plate and which includes at least two apertures penetrating therethrough in a direction perpendicular to a principal surface thereof,

applying an electromagnetic wave to the aperture array structure on which the specimen is held, and

detecting a frequency characteristic of the electromagnetic wave having transmitted through the aperture array structure,

wherein the aperture array structure has a lattice structure in which the apertures are periodically arrayed at least in one direction in the principal surface of the aperture array structure, and

a ratio (s/A) of a lattice spacing (s) of the aperture array structure to a thickness (A) of the specimen is 100 or less.

The ratio (s/A) is preferably 30 or less and more preferably 10 to 20.

The lattice spacing (s) of the aperture array structure is preferably 2600 μm or less.

A frequency of the electromagnetic wave is 0.1 THz or more.

The electromagnetic wave applied to the aperture array structure is preferably linearly polarized.

The aperture array structure preferably includes the apertures arrayed in a square pattern.

The aperture array structure is preferably arranged such that the aperture array structure is rotated about a particular rotation axis through a certain angle from a state where the principal surface thereof is perpendicular to a propagating direction of the electromagnetic wave and where one of array directions of the apertures is aligned with a polarizing direction of the electromagnetic wave.

Further, the present invention is concerned with an aperture array structure used in the measuring method described above.

Still further, the present invention is concerned with a measuring device comprising:

an aperture array structure for holding a specimen, the aperture array structure being formed of a flat plate and including at least two apertures that penetrate therethrough in a direction perpendicular to a principal surface thereof;

an irradiation unit for applying an electromagnetic wave to the aperture array structure on which the specimen is held; and

a detection unit for detecting the electromagnetic wave having transmitted through the aperture array structure,

the measuring device measuring characteristics of the specimen from a frequency characteristic of the detected electromagnetic wave,

wherein the aperture array structure has a lattice structure in which the apertures are periodically arrayed at least in one direction in the principal surface of the aperture array structure, and

a ratio (s/A) of a lattice spacing (s) of the aperture array structure to a thickness (A) of the specimen is 100 or less.

The electromagnetic wave applied to the aperture array structure is preferably linearly polarized.

According to the present invention, since a localized region of an electromagnetic field can be reduced by reducing the lattice spacing of the aperture array structure, a strong electromagnetic field can be produced near the principal surface of the aperture array structure in a concentrated manner. As a result, it is possible to measure even a specimen in a very small amount (i.e., a specimen having a small thickness relative to the surface of the aperture array structure) with high sensitivity and high efficiency.

### BRIEF DESCRIPTION OF THE DRAWINGS

FIG. 1 is a schematic view to explain a measuring method and a measuring device of the present invention.

FIG. 2A is a perspective view illustrating one example of the aperture array structure used in the present invention.

FIG. 2B is a schematic view to explain a lattice structure of the aperture array structure.

FIG. 3 is a schematic sectional view to explain one example of an installed state of the aperture array structure in the present invention.

FIG. 4 is a graph illustrating an electric field distribution with respect to an electromagnetic wave having a frequency of 1 THz in EXAMPLE 1-1.

FIG. 5 is a graph illustrating an electric field distribution with respect to an electromagnetic wave having a frequency of 10 THz in EXAMPLE 1-2.

FIG. 6 is a graph illustrating a transmittance spectrum obtained in EXAMPLE 2-1.

FIG. 7 is a graph illustrating a transmittance spectrum obtained in EXAMPLE 2-2.

FIG. 8 is a graph illustrating a transmittance spectrum obtained in COMPARATIVE EXAMPLE 1.

FIG. 9 is a graph illustrating a transmittance spectrum obtained in EXAMPLE 3.

FIG. 10 is a graph illustrating results obtained in EXAMPLE 4.

FIG. 11 is another graph illustrating results obtained in EXAMPLE 4.

### DETAILED DESCRIPTION OF THE PREFERRED EMBODIMENTS

An electromagnetic wave used in a measuring method of the present invention is preferably an electromagnetic wave (terahertz wave) having frequency of 20 GHz to 120 THz and more preferably an electromagnetic wave having frequency of 1 THz or higher.

One practical example of the electromagnetic wave is a terahertz wave that is generated with the optical rectification effect of an electro-optical crystal, e.g., ZnTe, by employing a short optical pulse laser as a light source. Another example is a terahertz wave that is obtained by employing a short optical pulse laser as a light source, exciting free electrons in a photoconductive antenna, and applying a voltage to the photoconductive antenna such that a current generates momentarily. Still another example is a terahertz wave that is emitted from a high-pressure mercury lamp or a high-temperature ceramic.

Further, the electromagnetic wave applied to the aperture array structure in the measuring method of the present invention is preferably a linearly-polarized electromagnetic wave. The linearly-polarized electromagnetic wave may be a linearly-polarized electromagnetic wave obtained after an electromagnetic wave emitted from a light source for, e.g., non-polarized light or circular polarized light, has passed through a (linear) polarizer, or a linearly-polarized electromagnetic wave emitted from a linearly-polarized light source. The linear polarizer may be, e.g., a wire grid.

In the measuring method of the present invention, the above-mentioned electromagnetic wave is applied to the aperture array structure on which a specimen is held, and characteristics of the specimen is measured by detecting a frequency characteristic of the electromagnetic wave that has transmitted through the aperture array structure.

The term “transmission” used in the present invention implies one form of forward scattering and preferably transmission in the 0-th order direction or reflection in the 0-th order direction. In general, given that a lattice spacing of a grating is s, an incidence angle is i, a diffraction angle is θ, and a wavelength is λ, a spectrum diffracted by the grating can be expressed by:

s(sin i−sin θ)=nλ (1)

The “0-th order” in the term “0-th order direction” implies the case where n in the above formula (1) is 0. Because s and λ cannot take 0, n=0 holds only when sin i−sin θ=0 is satisfied. Thus, the “0-th order direction” implies a direction given when the incidence angle and the diffraction angle are equal to each other, i.e., when a propagating direction of the electromagnetic wave is not changed.

In the present invention, the expression “measuring the characteristics of the specimen” implies quantitative measurement, various qualitative measurements, etc. of a compound as the specimen. There are, for example, the case of measuring a minute content of the specimen in, e.g., a solution, and the case of identifying the specimen. One practical method includes the steps of immersing the aperture array structure in a solution in which the specimen is dissolved, washing out a solvent and the extra specimen after the specimen has been attached to the surface of the aperture array structure, drying the aperture array structure, and measuring characteristics of the specimen by employing a measuring device described below.

In the present invention, when measuring an amount of the specimen, the amount of the specimen is preferably determined through comparison with a calibration curve that has been prepared on the basis of frequency characteristics obtained by measuring various amounts of the specimen in advance.

(Measuring Device)

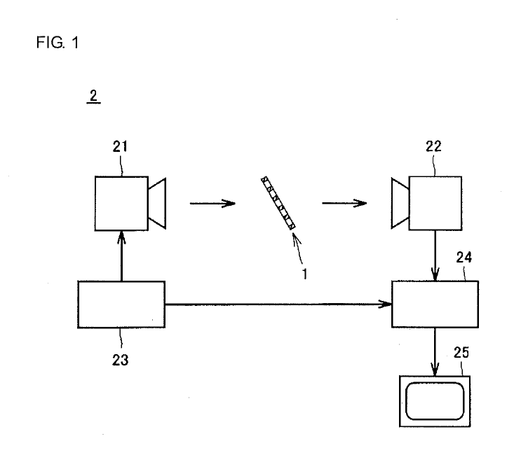

The outline of one example of a measuring device of the present invention will be described below with reference to FIG. 1. FIG. 1 is a schematic view illustrating an overall configuration of a measuring device 2 of the present invention and the layout of an aperture array structure 1 in the measuring device 2. As illustrated in FIG. 1, the measuring device 2 includes an irradiation unit 21 for generating and emitting an electromagnetic wave, and a detection unit 22 for detecting the electromagnetic wave that has transmitted through the aperture array structure 1. In addition, the measuring device 2 includes an irradiation control unit 23 for controlling the operation of the irradiation unit 21, an analysis processing unit 24 for analyzing the result detected by the detection unit 22, and a display unit 25 for displaying the result analyzed by the analysis processing unit 24. The irradiation control unit 23 may be further connected to the analysis processing unit 24 for the purpose of synchronizing the timing of the detection.

In the above-described measuring device 2, the irradiation unit 21 generates and emits the electromagnetic wave under control of the irradiation control unit 23. The electromagnetic wave emitted from the irradiation unit 21 is applied to the aperture array structure 1, and the electromagnetic wave having transmitted through the aperture array structure 1 is detected by the detection unit 22. The electromagnetic wave detected by the detection unit 22 is transferred as an electric signal to the analysis processing unit 24 and is displayed on the display unit 25 in the visually recognizable form, such as a frequency characteristic of transmittance (transmittance spectrum).

A detector used in the detection unit may be, for example, a bolometer such as a silicon bolometer or a germanium bolometer, or a pyroelectric sensor.

An interferometer may be disposed between the aperture array structure 1 and the detection unit 22 or between the irradiation unit 21 and the aperture array structure 1. The interferometer may be, for example, a Michelson interferometer or a Fabry-Perot interferometer. In the case using the interferometer, the light source may be, for example, a high-pressure mercury lamp or a high-temperature ceramic.

(Aperture Array Structure)

The aperture array structure used in the measuring method of the present invention has the following features. It is an aperture array structure, which is in the form of a flat plate and which has at least two apertures penetrating through the aperture array structure in a direction perpendicular to a principal surface thereof. The aperture array structure has a lattice structure that the apertures are periodically arrayed in the principal surface of the aperture array structure in at least one direction. Further, a ratio (s/A) of a lattice spacing (s) of the aperture array structure to a thickness (A) of the specimen is 100 or less. The ratio (s/A) is preferably 30 or less, more preferably 10 to 20 or less, and most preferably about 15. Here, the “thickness (A) of the specimen” implies an average value of heights of the specimen, which is in a state held on the aperture array structure, in a direction normal to the principal surface of the aperture array structure, the average value being averaged over an area of the principal surface of the aperture array structure.

The aperture array structure used in the present invention is a structure in which at least one aperture penetrating through the aperture array structure in the direction perpendicular to the principal surface thereof is periodically arrayed in the principal surface in at least one direction. However, the apertures are not always required to be periodically arrayed over the entire aperture array structure. It is just required that the apertures are periodically arrayed in at least a portion of the aperture array structure.

Preferably, the aperture array structure is a quasi-periodic structure or a periodic structure. The term “quasi-periodic structure” implies a structure in which translational symmetry is not held, but the array is orderly kept. Examples of the quasi-periodic structure include a Fibonacci structure as a one-dimensional quasi-periodic structure, and a Penrose structure as a two-dimensional quasi-periodic structure. The term “periodic structure” implies a structure having spatial symmetry such as represented by translational symmetry. The periodic structure is classified into one-dimensional periodic structure, a two-dimensional periodic structure, and a three-dimensional periodic structure depending on the number of dimensions of symmetry. The one-dimensional periodic structure is, for example, a wire grid structure or a one-dimensional grating. The two-dimensional periodic structure is, for example, a mesh filter or a two-dimensional grating. Among those periodic structures, the two-dimensional periodic structure is preferably employed. More preferably, a two-dimensional periodic structure including apertures regularly arrayed in both vertical and horizontal directions (i.e., in a quadrate array) is employed.

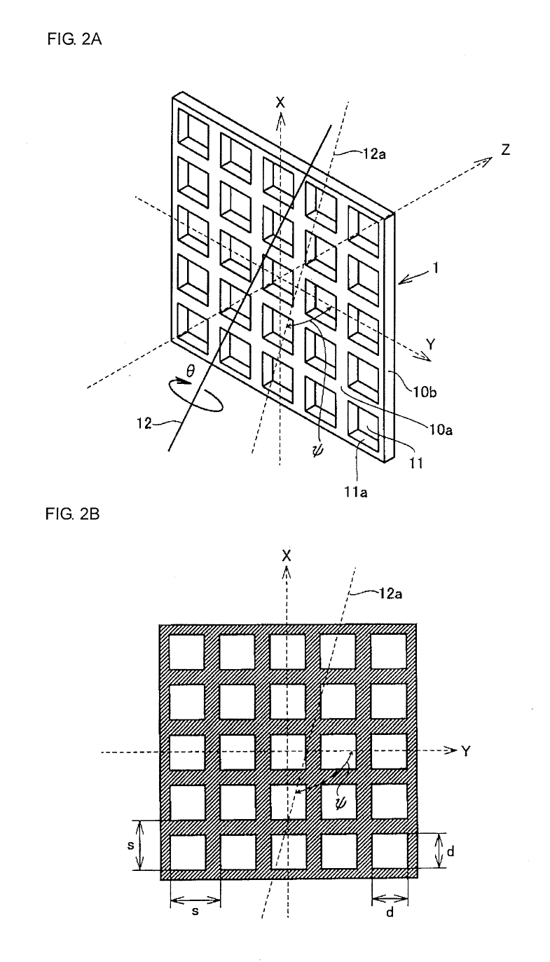

One example of the two-dimensional periodic structure including the apertures in the quadrate array is a plate-like structure (lattice structure) in which the apertures are arrayed in a matrix pattern at a constant spacing, as illustrated in FIGS. 2A and 2B. The aperture array structure 1, illustrated in FIG. 2A, is a plate-like structure in which apertures 11, each having a square shape when viewed from the side facing a principal surface 10a, are formed at a constant spacing in two array directions (vertical and horizontal directions in FIG. 2B) that are parallel respectively to two sides of the square shape of each aperture. The shape of the aperture is not limited to the square, and it may be, e.g., rectangular, circular, or elliptic. Further, respective spacings in the two array directions may be not equal to each other insofar as the apertures are in the quadrate array. For example, the apertures are in a rectangular array.

The shape and the size of the apertures of the aperture array structure are designed, as appropriate, depending on the measuring method, the material characteristics of the aperture array structure, the frequency of the electromagnetic wave used, etc. Hence there is a difficulty in generalizing respective ranges of parameters of the apertures. However, when the transmitted electromagnetic wave is detected, it is preferable in the aperture array structure 1 illustrated in FIG. 2A that the lattice spacing between the apertures, denoted by s in FIG. 2B, is not shorter than 1/10 time and not longer than 10 times the wavelength of the electromagnetic wave used in the measurement. If the lattice spacing (s) between the apertures is outside that range, the electromagnetic wave may become hard to transmit through the apertures in some cases.

According to the present invention, even a specimen in a very small amount (i.e., even a specimen being so thin) can be measured with high sensitivity by employing the aperture array structure in which the lattice spacing between the apertures is small, thereby reducing the spreading of an electromagnetic field that is localized on the surface of the aperture array structure when the structure surface is irradiated with the electromagnetic wave. Desirably, the frequency of the electromagnetic wave applied to the aperture array structure is increased at the same time as reducing the lattice spacing of the aperture array structure. Given that the lattice spacing of the aperture array structure is s, the spreading Z of an electromagnetic field localized in the surface of the aperture array structure (i.e., the spreading thereof in a propagating direction of the electromagnetic wave) is provided by s/Z=15. The reason is that an electric field becomes 1/e at a distance of λ/15 from the vicinity of the structure surface. On other hand, given that the thickness of the specimen is A, Z≈A is desirably satisfied. The reason is that the localized electromagnetic wave and the specimen develop a strong interaction. In that case, the lattice spacing s of the aperture array structure is about 15 times A (i.e., s/A=15).

Regarding the hole size of the aperture, it is preferable that the hole size of the aperture, denoted by d in FIG. 2B, is not smaller than 1/10 time and not larger than 10 times the wavelength of the electromagnetic wave used in the measurement. If the hole size (d) of the aperture is outside that range, the intensity of the transmitted electromagnetic wave may be reduced to such an extent as causing a difficulty in detecting the signal in some cases.

Furthermore, the thickness (t) of the aperture array structure is designed, as appropriate, depending on the measuring method, the material characteristics of the aperture array structure, the frequency of the electromagnetic wave used, etc. Hence there is a difficulty in generalizing a range of the structure thickness. However, when the transmitted electromagnetic wave is detected, the structure thickness is preferably not larger than several times the wavelength of the electromagnetic wave used in the measurement. If the structure thickness is outside that range, the intensity of the transmitted electromagnetic wave may be reduced to such an extent as causing a difficulty in detecting the signal in some cases.

In the present invention, the specimen can be held on the aperture array structure by optionally using one of various known methods. For example, the specimen may be directly attached to the aperture array structure or may be attached to it with, e.g., a support film interposed therebetween. However, the specimen is preferably directly attached to the surface of the aperture array structure from the viewpoint of improving measurement sensitivity and reducing variations in the measurement, thereby performing the measurement with higher reproducibility.

Direct attachment of the specimen to the aperture array structure includes not only the case where chemical bonding, for example, is directly formed between the surface of the aperture array structure and the specimen, but also the case where, by using the aperture array structure having the surface to which a host molecule is bonded in advance, the specimen is bonded to the host molecule. Examples of the chemical bonding include covalent bonding (e.g., covalent bonding between a metal and a thiol group), Van der Waals bonding, ionic bonding, metal bonding, and hydrogen bonding. Of those examples, the valence bonding is preferable. The term “host molecule” implies a molecule capable of causing the specimen to be specifically bonded to it. Combinations of the host molecule and the specimen are, for example, an antigen and an antibody, a sugar chain and a protein, a lipid and a protein, a low-molecule compound (ligand) and a protein, a protein and a protein, a single strand DNA and a single strand DNA.

When the specimen is directly attached to the aperture array structure, it is preferable to use the aperture array structure in which at least a part of its surface is formed of a conductor. The expression “at least a part of the surface of the aperture array structure 1” implies, for example, a part of any of the principal surface 10a, a side surface 10b, and a side surface 11a of the aperture, which are illustrated in FIG. 2A.

Herein, the term “conductor” implies an object (substance) capable of conducting electricity therethrough, and it includes not only a metal, but also a semiconductor. Examples of the metal include a metal capable of bonding to a functional group, such as a hydroxyl group, a thiol group, or a carboxyl group, of a compound containing that functional group, a metal allowing a functional group, such as a hydroxyl group or an amino group, to be coated on a surface of the metal, and alloys of those metals. More specifically, the metals are gold, silver, copper, iron, nickel, chromium, silicon, germanium, etc. Of those examples, gold, silver, copper, nickel, and chromium are preferable. Gold is more preferable. Using gold or nickel is advantageous in that, particularly when the specimen contains a thiol group (—SH group), the thiol group can be bonded to the surface of the aperture array structure. Furthermore, using nickel is advantageous in that, particularly when the specimen contains a hydroxyl group (—OH) or a carboxyl group (—COOH), such a functional group can be bonded to the surface of the aperture array structure. Examples of the semiconductor include a group IV semiconductor (e.g., Si or Ge), compound semiconductors, and organic semiconductors, the compound semiconductors being, e.g., a group II-VI semiconductor (e.g., ZnSe, Cds or ZnO), a group III-V semiconductor (e.g., GaAs, InP or GaN), a group IV compound semiconductor (e.g., SiC or SiGe), and a group semiconductor (e.g., CuInSe₂).

When attaching the specimen to the aperture array structure with, e.g., a support film interposed therebetween, the attachment can be performed, for example, by a method of pasting a support film made of, e.g., a polyamide resin to the surface of the aperture array structure and attaching the specimen to the support film. Alternatively, there is a method of using a gas-tight or liquid-tight container instead of the support film, and measuring a fluid or a substance dispersed in a fluid.

(Condition for Appearance of Dip Waveform)

Preferably, a dip waveform appears in the frequency characteristic of, e.g., the transmittance spectrum obtained with the measuring method of the present invention. Herein, the term “dip waveform” implies a local inverse peak that usually appears in a frequency region (bandpass region) of a transmittance spectrum, for example, where the transmittance of the electromagnetic wave is high.

The dip waveform appearing in the frequency characteristic is preferably produced with TE11-mode resonance (when each aperture is regarded as a waveguide) of the aperture array structure. Alternatively, the dip waveform is preferably produced with a reduction in TE10-mode resonance (when each aperture is regarded as a waveguide) of the aperture array structure. The reason is that the dip waveform appearing in the frequency characteristic is sharpened and measurement sensitivity is improved.

One example of the condition for causing the dip waveform to appear with the TE11-mode resonance (or the reduction in the TE10-mode resonance) of the aperture array structure is to arrange the aperture array structure such that the aperture array structure is rotated through a certain angle around a particular rotation axis from a posture perpendicular to the propagating direction of a first electromagnetic wave. In one practical arrangement, on condition, for example, that the propagating direction of the electromagnetic wave is the Z-axis direction and the polarizing direction of the electromagnetic wave is one (X-axis direction) of directions perpendicular to the Z-axis direction, the aperture array structure is preferably arranged to be rotated through a certain angle about a rotation axis, which is an axis (Y-axis) passing the center of gravity of the aperture array structure and being parallel to a direction (Y-direction) perpendicular to both the X-axis direction and the Z-axis direction, from a state where the principal surface of the aperture array structure is perpendicular to the Z-axis direction.

The aperture array structure is preferably arranged in a posture rotated through a certain angle about a particular rotation axis from a state where the principal surface of the aperture array structure is perpendicular to the propagating direction of the electromagnetic wave and where one of the array directions of the apertures and a polarizing direction of the electromagnetic wave are aligned with each other. Further, preferably, an angle formed between a projected line, which is obtained by projecting the rotation axis to the principal surface of the aperture array structure, and the polarizing direction of the electromagnetic wave is other than 0°. In addition, preferably, the rotation axis is parallel to the principal surface of the aperture array structure. Those features of the present invention will be described below with reference to FIG. 2.

In the aperture array structure 1 illustrated in FIG. 2A, the apertures 11 are arrayed at a constant spacing in both the vertical and horizontal directions (i.e., in a square pattern). In FIG. 2A, the horizontal array direction of the apertures 11 is defined as a Y-axis, and the vertical array direction of the apertures 11 is defined as an X-axis. Furthermore, the direction perpendicular to an X-Y plane is defined as a Z-axis. The propagating direction of the electromagnetic wave applied to the aperture array structure 1 is the Z-axis direction denoted in FIG. 2A, and the polarizing direction of the electromagnetic wave is the Y-axis direction denoted in FIG. 2A.

FIG. 2A illustrates a state where the principal surface 10a of the aperture array structure 1 is perpendicular to the propagating direction (Z-axis) of the electromagnetic wave, and where one of the array directions of the apertures 11 is aligned with the polarizing direction of the electromagnetic wave, i.e., with the Y-axis direction. In the present invention, the aperture array structure 1 is arranged in a posture rotated about a particular rotation axis 12 through a certain angle θ from the above-mentioned state. Further, preferably, an angle ψ formed between a projected line 12a, which is obtained by projecting the rotation axis 12 to the principal surface 10a of the aperture array structure 1, and the polarizing direction of the electromagnetic wave (i.e., the Y-axis direction) is other than 0°. The rotation axis 12 may be positioned away from the aperture array structure 1. While FIG. 2A illustrates the case where the rotation axis 12 is twisted with respect to the principal surface 10a of the aperture array structure 1, the rotation axis 12 is preferably parallel to the principal surface 10a of the aperture array structure 1.

Given, e.g., θ=9° on those conditions, sharpness of a dip appearing in a frequency characteristic, such as a transmittance spectrum, depends on the angle ψ, and there is a value of the angle ψ at which the sharpness of a dip waveform is maximized. When the aperture array structure 1 is constituted with the square array of the apertures 11, the dip waveform appears in the transmittance spectrum at the angle ψ other than 0° (namely, no dip appears at ψ=0). As the angle ψ approaches 90°, the dip waveform becomes sharper and the sharpness is maximized at the angle ψ of 90°. Thus, the angle ψ formed between the rotation axis 12 and the polarizing direction (Y-axis direction) of the electromagnetic wave is preferably 1° to 90°, more preferably 30° to 90°, even more preferably 60° to 90°, and most preferably 85° to 90°.

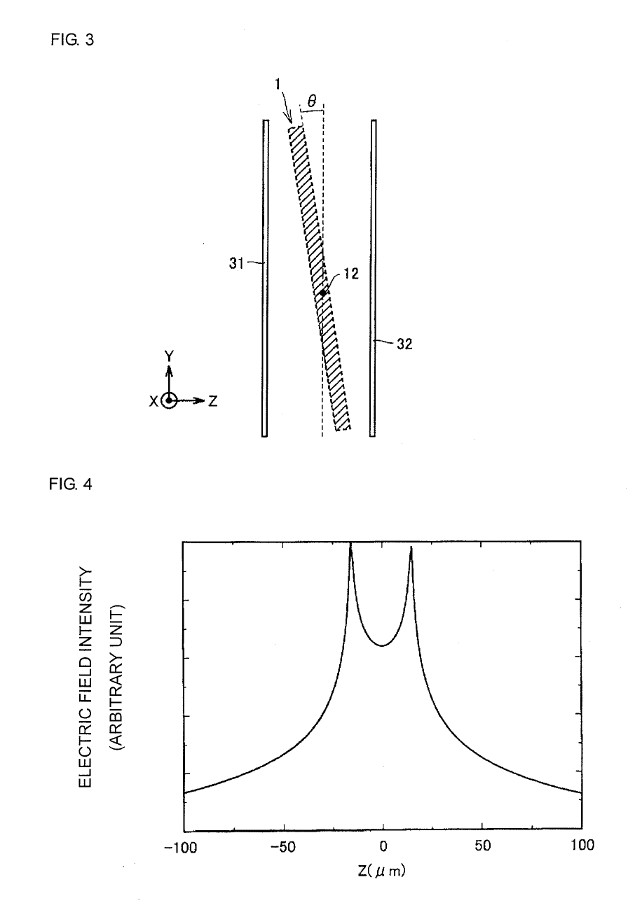

FIG. 3 is a schematic sectional view illustrating one example of an installed state of the aperture array structure when the angle ψ formed between the projected line 12a of the rotation axis 12 and the polarizing direction of the electromagnetic wave (i.e., the Y-axis direction) is 90°. FIG. 3 illustrates a state where the aperture array structure is rotated through the angle θ about the rotation axis 12 that is parallel to the X-axis direction (i.e., the direction perpendicular to the drawing sheet) and that passes the center of gravity of the aperture array structure.

The dip waveform with the TE11-mode resonance can also be produced by, instead of inclining the aperture array structure relative to the propagating direction and the polarizing direction of the electromagnetic wave as described above, by forming the apertures of the aperture array structure in a shape that is not mirror-symmetric with respect to an imaginary plane orthogonal to the polarizing plane of the electromagnetic wave. In that case, the dip waveform with the TE11-mode resonance is produced even when the aperture array structure is arranged perpendicularly to the propagating direction of the electromagnetic wave.

To provide such an aperture shape, the periodic structure may include, e.g., a projection or a cutout in its portion forming the aperture. In that case, preferably, the projection is provided at a position in the aperture-forming portion of the periodic structure where the electric field intensity is relatively intensified when the TE11 mode-like resonance is produced, or the cutout is preferably provided at a position in the aperture-forming portion where the electric field intensity is relatively weakened when the TE11 mode-like resonance is produced. Furthermore, the aperture shape as viewed in the direction perpendicular to the principal surface of the periodic structure may be, e.g., trapezoidal, convex, concave, polygonal, or star-like, and the aperture array structure may be arranged such that the aperture shape is not mirror-symmetric with respect to the imaginary plane perpendicular to the polarizing direction of the first electromagnetic wave. Even when the aperture shape is one of those examples, the lattice spacing is defined as a repetition unit length in the array direction of the apertures in the same manner as for s denoted in FIG. 2(b).

The measuring method of the present invention can be applied to not only the case of detecting the frequency characteristic of the electromagnetic wave that has transmitted (scattered forward) through the aperture array structure, but also the case of detecting the frequency characteristic of the electromagnetic wave that has been reflected (scattered backward) by the aperture array structure. The measuring method applied to the latter case is also involved in the present invention. It is to be noted that the dip waveform in the transmission spectrum appears as a peak waveform in a reflection spectrum.

### EXAMPLES

The present invention will be described in detail below in connection with EXAMPLES, but the present invention is not limited to the following EXAMPLES.

### Example 1-1

For a model in which the aperture array structure (metal mesh) 1 was installed between the two ports 31 and 32 arranged with a spacing of 460 μm therebetween as illustrated in FIG. 3, an electric field distribution (distribution of electric field intensity) was calculated with simulation using the electromagnetic-field simulator MicroStripes (made by CST AG.) by setting periodic boundary conditions in the X-axis direction (i.e., the direction perpendicular to the drawing sheet) and the Y-axis direction, both the directions being illustrated in FIG. 3.

The distance between the port 31 and the center of gravity of the aperture array structure 1 and the distance between the port 32 and the center of gravity of the aperture array structure 1 were each set to 230 μm. Each of the ports 31 and 32 was a plate-like member having a principal surface of 1.3 mm square and a thickness of 60 μm. The port 31 was utilized as an output member and a detection member for the electromagnetic wave, and the port 32 was utilized as a detection member for the electromagnetic wave.

The aperture array structure used as a model in this EXAMPLE was a metal mesh entirely made of a metal (perfect conductor) and having square holes (apertures) that were arrayed in a square lattice pattern as illustrated in the schematic views of FIGS. 2A and 2B. The lattice spacing (denoted by s in FIG. 2(b)), the hole size (denoted by d in FIG. 2(b)), and the thickness of the metal mesh were respectively 260 μm, 180 μm, and 30 μm. The entirety of the metal mesh had a plate-like shape of 1.3 mm square.

The propagating direction of the electromagnetic wave applied to the aperture array structure was set to the Z-axis direction in FIG. 3. The polarizing direction was set to the Y-axis direction in FIG. 3, and the polarizing direction of the electromagnetic wave detected at each port was also set to the Y-axis direction. The metal mesh was arranged such that its principal surfaces were perpendicular to the propagating direction (Z-axis direction) of the electromagnetic wave (i.e., in the state illustrated in FIG. 2A). In other words, the incidence angle of the electromagnetic wave was set to be vertical incidence (θ=0° in FIG. 3).

In this EXAMPLE, the metal mesh was irradiated with the electromagnetic wave having a frequency of 1 THz and a wavelength (300 μm) close to the lattice spacing (260 μm) of the metal mesh.

FIG. 4 illustrates an electric field distribution in the direction perpendicular to the principal surfaces of the aperture array structure (i.e., in the Z-axis direction) when the electromagnetic wave having the frequency of 1 THz was applied. It is to be noted that FIG. 4 illustrates the electric field distribution over the range of −100 μm to 100 μm in the Z-coordinate when the origin of the Z-coordinate is coincident with a midpoint of the metal mesh in the thickness direction thereof.

As illustrated in FIG. 4, the electric field intensity attenuates as the distances from the principal surfaces of the metal mesh increase in the Z-axis direction, i.e., in the propagating direction of the electromagnetic wave (both the positive and negative directions). When the electric field intensity attenuates to 1/e (e denotes natural logarithm) with respect to the electric field intensity obtained at positions (Z=±15 μm) of the principal surfaces of the metal mesh, the Z-coordinates are Z=±35 μm. This indicates that the electric field intensity at a position 20 μm away from each principal surface of the metal mesh attenuates to 1/e with respect to the electric field intensity at the principal surface of the metal mesh. The distance (20 μm) from the principal surface of the metal mesh corresponds to 1/15 of the wavelength (300 μm) of the electromagnetic wave of 1 THz.

### Example 1-2

An electric field distribution was determined in the same manner as in EXAMPLE 1-1 except that the lattice spacing (s), the hole size (d), and the thickness of the metal mesh were set respectively to 26 μm, 18 μm, and 6 μm. In this EXAMPLE, the metal mesh was irradiated with an electromagnetic wave having a frequency of 10 THz and a wavelength (30 μm) close to the lattice spacing (26 μm) of the metal mesh.

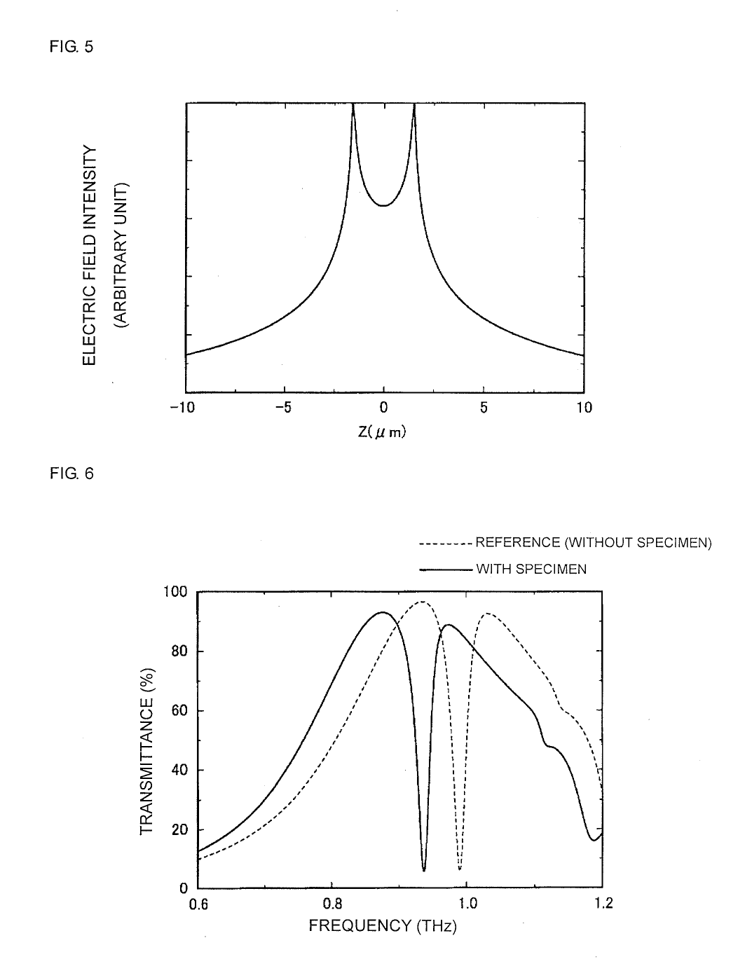

FIG. 5 illustrates an electric field distribution in the direction perpendicular to the principal surfaces of the aperture array structure (i.e., in the Z-axis direction) when the electromagnetic wave having the frequency of 10 THz was applied. It is to be noted that FIG. 5 illustrates the electric field distribution over the range of −10 μm to 10 μm in the Z-coordinate when the origin of the Z-coordinate is coincident with a midpoint of the metal mesh in the thickness direction thereof.

As illustrated in FIG. 5, the electric field intensity attenuates as the distances from the principal surfaces of the metal mesh increase in the Z-axis direction (both the positive and negative directions). When the electric field intensity attenuates to 1/e with respect to the electric field intensity obtained at positions (Z=±1.5 μm) of the principal surfaces of the metal mesh, the Z-coordinates are Z=±3.5 μm. This indicates that the electric field intensity at a position 2 μm away from each principal surface of the metal mesh attenuates to 1/e with respect to the electric field intensity at the principal surface of the metal mesh. The distance (2 μm) from the principal surface of the metal mesh corresponds to 1/15 of the wavelength (30 μm) of the electromagnetic wave of 10 THz.

In the present invention, since the localized region of the electromagnetic field can be reduced by reducing the lattice spacing of the aperture array structure, the electric field distribution can be further sharpened (i.e., a Q-value can be further increased), and a stronger electromagnetic field can be produced near each principal surface of the aperture array structure. Accordingly, even a specimen in a very small amount (i.e., even a specimen being so thin) can be measured with high sensitivity and high efficiency.

### Example 2-1

For a model, similar to that in EXAMPLE 1-1, in which the metal mesh 1 was installed between the two ports 31 and 32 as illustrated in FIG. 3, a transmittance spectrum was calculated with simulation using the electromagnetic-field simulator MicroStripes (made by CST AG.) by setting periodic boundary conditions in the X-axis direction (i.e., the direction perpendicular to the drawing sheet) and the Y-axis direction.

The metal mesh used here was a structure entirely made of a metal (perfect conductor) and having square holes that were arrayed in a square lattice pattern as illustrated in the schematic view of FIG. 2. The lattice spacing (s), the hole size (d), and the thickness of the metal mesh were respectively 260 μm, 180 μm, and 60 μm. The entirety of the metal mesh had a plate-like shape of 1.3 mm square.

The distance between the port 31 and the center of gravity of the aperture array structure 1 and the distance between the port 32 and the center of gravity of the aperture array structure 1 were each set to 230 μm. Each of the ports 31 and 32 was a plate-like member having a principal surface of 1.3 mm square and a thickness of 10 μm. The port (31) was utilized as an output member for the electromagnetic wave, and both the ports were utilized as members for measuring the amount of light. The frequency of the incident electromagnetic wave was set to 1 THz, and the polarizing direction thereof was set to the Y-axis direction in FIG. 2. The polarizing direction of the electromagnetic wave detected at each port was also set to the Y-axis direction.

The metal mesh was arranged such that it was rotated about the rotation axis 12, which was a linear line passing the center of gravity of the metal mesh and being parallel to the X-axis, from a state where the principal surfaces of the metal mesh were perpendicular to the propagating direction (Z-axis direction) of the electromagnetic wave (i.e., in the state illustrated in FIG. 2A) (i.e., that the angle (denoted by ψ in FIG. 2A formed between the projected line resulting from projecting the rotation axis 12 to the principal surface of the metal mesh and the Y-axis direction was 90°). The angle (denoted by θ in FIG. 3) through which the metal mesh was rotated was set to 9°.

The obtained transmittance spectrum is indicated by a dotted line in FIG. 6.

Next, a frequency characteristic was determined for a specimen (dielectric film having a relative dielectric constant of 2.4, a dielectric loss tangent of 0.01, a thickness of 10 μm, and 1.3 mm square), which was held in close contact with the principal surface of the metal mesh, in the same manner as that described above. The determined transmittance spectrum is depicted by a solid line in FIG. 6.

In FIG. 6, looking at a dip waveform, the frequency of a minimum value of the dip waveform in the presence of the specimen (depicted by the solid line) is shifted about 53 GHz toward the lower frequency side than that of a minimum value of the dip waveform in the absence of the specimen (depicted by the dotted line).

The term “dip waveform” implies a local inverse peak that usually appears in, e.g., a transmittance spectrum within a frequency region (bandpass region) where transmittance of the electromagnetic wave is high. In FIG. 6, an inverse peak appearing in the range of about 0.9 to 1.0 THz within a bandpass region spanning over the range of about 0.6 to 1.2 THz is the dip waveform.

### Example 2-2

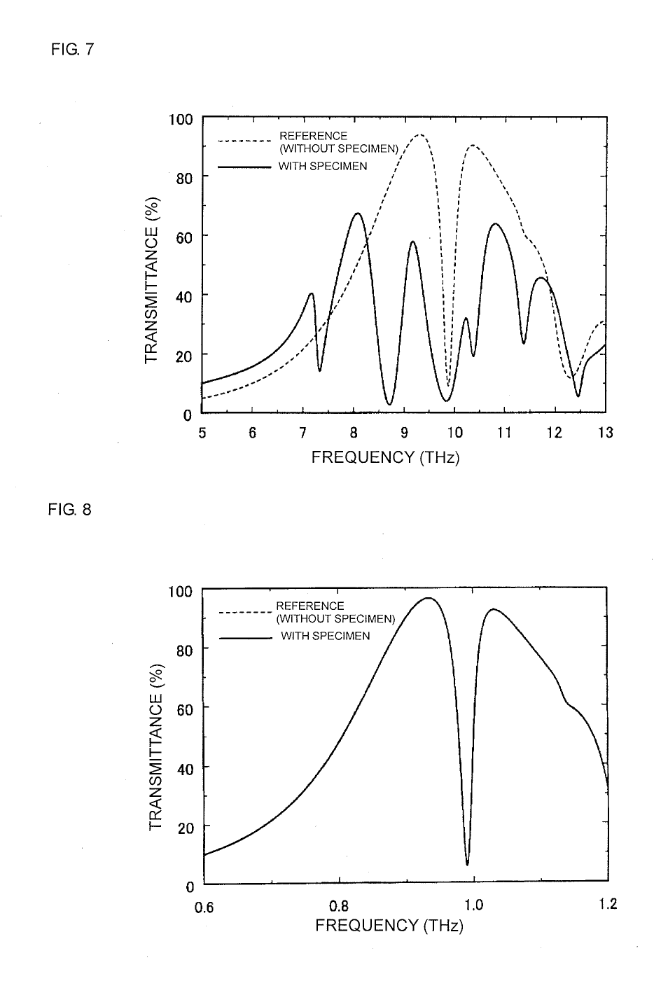

A transmittance spectrum was determined in the same manner as in EXAMPLE 2-1 except for using a metal mesh (plate-like member in an entire shape of 1.3 mm square) having the lattice spacing (s) of 26 μm, the hole size (d) of 18 μm, and the thickness of 6 μm, and for setting the frequency of the electromagnetic wave to 10 THz. The transmittance spectrum obtained with the metal mesh alone is depicted by a dotted line in FIG. 7. The transmittance spectrum obtained with a specimen, which is the same as that used in EXAMPLE 2-1 and which is held in close contact with a principal surface of the metal mesh, is depicted by a solid line in FIG. 7.

In FIG. 7, looking at the dip waveform, the frequency of a minimum value of the dip waveform in the presence of the specimen (depicted by the solid line) is shifted about 2550 GHz toward the lower frequency side than that of a minimum value of the dip waveform in the absence of the specimen (depicted by the dotted line).

As seen from comparing FIG. 6 (EXAMPLE 2-1) with FIG. 7 (EXAMPLE 2-2), measurement sensitivity is increased 48 times by setting the lattice spacing of the metal mesh to 1/10 because respective dip shifts are 53 GHz and 2550 GHz for the specimens having the same thickness. The term “dip shift” implies an amount by which the frequency of a minimum value of the dip waveform in the transmittance spectrum is shifted in the presence of the specimen in comparison with that in the transmittance spectrum in the absence of the specimen.

### Comparative Example 1

For the model in which the aperture array structure (metal mesh) 1 was installed between the two ports arranged with the spacing of 460 μm therebetween as illustrated in FIG. 3, a transmittance spectrum was calculated with simulation using the electromagnetic-field simulator MicroStripes (made by CST AG.) by setting periodic boundary conditions in the X-axis direction and the Y-axis direction.

The metal mesh used here was a structure entirely made of a metal (perfect conductor) and having square holes that were arrayed in a square lattice pattern as illustrated in the schematic view of FIG. 2. The lattice spacing (s), the hole size (d), and the thickness of the metal mesh were respectively 260 μm, 180 μm, and 60 μm. The entirety of the metal mesh had a plate-like shape of 1.3 mm square.

The distance between the port 31 and the center of gravity of the aperture array structure 1 and the distance between the port 32 and the center of gravity of the aperture array structure 1 were each set to 230 μm. Each of the ports 31 and 32 was a plate-like member having a principal surface of 1.3 mm square and a thickness of 10 μm. The port (31) was utilized as an output member for the electromagnetic wave, and both the ports were utilized as members for measuring the amount of light. The polarizing direction of the incident electromagnetic wave was set to the Y-axis direction in FIG. 3. The polarizing direction of the electromagnetic wave detected at each port was also set to the Y-axis direction.

The rotation axis (12) was set as a linear line passing the center of gravity of the metal mesh and being parallel to a principal surface of the metal mesh, and an angle (denoted by ψ in FIG. 2A) formed between a projected line resulting from projecting the rotation axis to the principal surface of the metal mesh and the Y-axis was set to 90°. An incidence angle of the electromagnetic wave was set to be oblique incidence (θ denoted in FIG. 3=9°). The obtained transmittance spectrum is depicted by a dotted line in FIG. 8.

Next, a frequency characteristic was determined for a specimen (dielectric film having a relative dielectric constant of 2.4, a dielectric loss tangent of 0.01, a thickness of 2 μm, and 1.3 mm square), which was held in close contact with the principal surface of the metal mesh, in the same manner as that described above. The determined transmittance spectrum is depicted by a solid line in FIG. 8.

In COMPARATIVE EXAMPLE 1, the frequency of a minimum value of a dip waveform is hardly shifted between the case of the presence of the specimen (solid line) and the case of the absence of the specimen (dotted line), and the dip shift is substantially 0 (note that FIG. 8 illustrates only the solid line because the transmittance spectra depicted by the solid line and the dotted line are coincident with each other).

### Example 3

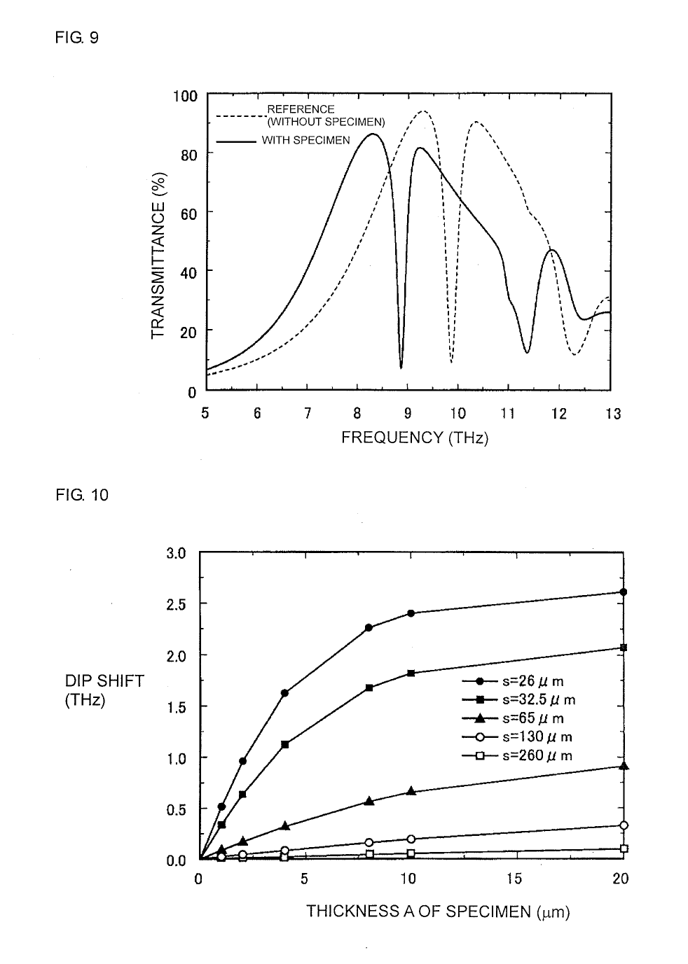

A transmittance spectrum was determined in the same manner as in COMPARATIVE EXAMPLE 1 except for using a metal mesh (plate-like member in an entire shape of 1.3 mm square) having the lattice spacing (s) of 26 μm, the hole size (d) of 18 μm, and the thickness of 6 μm. The obtained transmittance spectrum is depicted by a dotted line in FIG. 9. The transmittance spectrum obtained with a specimen (dielectric film having a relative dielectric constant of 2.4, a dielectric loss tangent of 0.01, a thickness of 2 μm, and 1.3 mm square), which is the same as that used in COMPARATIVE EXAMPLE 1 and which is held in close contact with a principal surface of the metal mesh, is depicted by a solid line in FIG. 9.

In FIG. 9, looking at the dip waveform, the frequency of a minimum value of the dip waveform in the presence of the specimen (depicted by the solid line) is shifted about 1002 GHz toward the lower frequency side than that of a minimum value of the dip waveform in the absence of the specimen (depicted by the dotted line).

As seen from comparing COMPARATIVE EXAMPLE 1 (FIG. 8) with EXAMPLE 3 (FIG. 9) using the specimens with the same thickness, the one specimen cannot be detected when the lattice spacing is 260 μm, but the other specimen can be detected by setting the lattice spacing to 1/10.

Table 1 lists the lattice spacing (s), the thickness (A) of the specimen, the ratio s/A, and the position shift of the dip waveform (dip shift) for each of EXAMPLES and COMPARATIVE EXAMPLE described above.

TABLE 1

| | EXAMPLE | EXAMPLE | COMPARATIVE | EXAMPLE |
|---|---|---|---|---|
| | 2-1 | 2-2 | EXAMPLE 1 | 3 |
| s (μm) | 260 | 26 | 260 | 26 |
| A (μm) | 10 | 10 | 2 | 2 |
| s/A | 26 | 2.6 | 130 | 13 |
| Dip shift | 53 | 2550 | ≈0 | 1002 |
| (GHz) | | | | |

### Example 4

In this EXAMPLE, five types of metal meshes (each being a plate-like member in an entire shape of 1.3 mm square) having the lattice spacings (s), the hole sizes (d), and the thicknesses, as per listed in Table 2, were used as models. For each of the metal meshes, a transmittance spectrum was determined with simulation for specimens (each being a dielectric film having a relative dielectric constant of 2.4, a dielectric loss tangent of 0.01, and 1.3 mm square), which had thicknesses changed to 1, 2, 4, 8, 10 and 20 μm and which were each held in close contact with the metal mesh, in the same manner as that in EXAMPLE 3. Further, dip shifts were determined for the specimens.

TABLE 2

| | | | | | |
|---|---|---|---|---|---|
| s (μm) | 26 | 32.5 | 65 | 130 | 260 |
| d (μm) | 18 | 22.5 | 45 | 90 | 180 |
| Thickness (μm) | 6 | 7.5 | 15 | 30 | 60 |

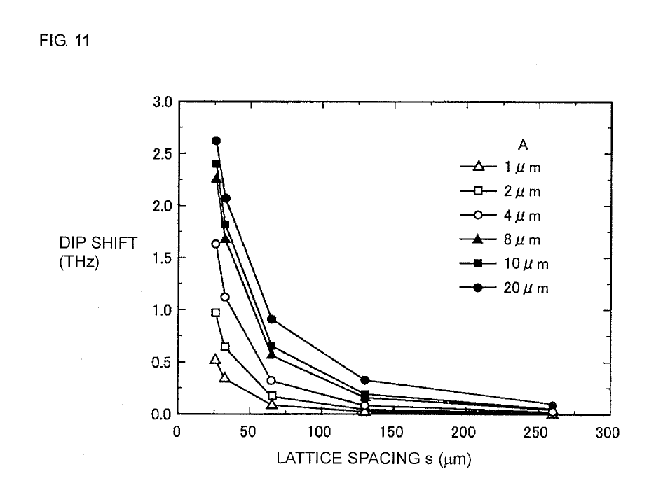

A graph of FIG. 10 represents the relationship between the thickness A of the specimen (horizontal axis) and the dip shift (vertical axis) for each of the metal meshes. Further, a graph of FIG. 11 represents the relationship between the lattice spacing s of the metal mesh (horizontal axis) and the dip shift (vertical axis) for each value of the thicknesses A of the specimen.

As seen from FIGS. 10 and 11, a dip shift necessary for the measurement is obtained when the ratio (s/A) of the lattice spacing (s) of the aperture array structure to the thickness (A) of the specimen is 100 or less, and a more sufficient dip shift is obtained when the ratio (s/A) is 30 or less.

For example, in the graph of FIG. 10 representing the case of s=65 μm, the dip necessary for the measurement is obtained on the side rightward of A=1 μm (i.e., when s/A is 65 or less). Further, the more sufficient dip shift is obtained on the side rightward of A=2 μm (i.e., when s/A is 32.5 or less).

In the graph of FIG. 11 representing the case of A=2 μm, the dip necessary for the measurement is obtained on the side leftward of s=130 (i.e., when s/A is 65 or less). Further, the more sufficient dip shift is obtained on the side leftward of s=65 μm (i.e., when s/A is 32.5 or less).

The embodiments and EXAMPLES disclosed herein should be considered in all respects as illustrative and not restrictive. The scope of the present invention is defined in the claims instead of the foregoing description and is intended to involve all of modifications that are equivalent to the claims in terms of meaning and that fall within the scope of the claims.

### REFERENCE SIGNS LIST

1 aperture array structure (metal mesh), 10a principal surface, 10b side surface, 11 aperture, 11a side surface of aperture, 12 rotation axis, 12a projected line, 2 measuring device, 21 irradiation unit, 22 detection unit, 23 irradiation control unit, 24 analysis processing unit, 25 display unit, and 31, 32 ports.

1. A method of measuring characteristics of a specimen, the method comprising:
applying an electromagnetic wave to an aperture array structure on which the specimen is held; and
detecting a frequency characteristic of the electromagnetic wave having transmitted through the aperture array structure,
wherein the aperture array structure is a flat plate that includes at least two apertures penetrating therethrough in a direction perpendicular to a principal surface thereof, and has a lattice structure in which the at least two apertures are periodically arrayed at least in one direction along the principal surface, and
a ratio (s/A) of a lattice spacing (s) of the aperture array structure to a thickness (A) of the specimen is 100 or less.

2. The measuring method according to claim 1, wherein the ratio (s/A) is 30 or less.

3. The measuring method according to claim 1, wherein the ratio (s/A) is 10 to 20.

4. The measuring method according to claim 1, wherein the electromagnetic wave applied to the aperture array structure is linearly polarized.

5. The measuring method according to claim 1, wherein the lattice spacing (s) of the aperture array structure is 2600 μm or less.

6. The measuring method according to claim 1, wherein a frequency of the electromagnetic wave is 0.1 THz or more.

7. The measuring method according to claim 1, wherein the at least two apertures of the aperture array structure are included in a square pattern.

8. The measuring method according to claim 1, wherein the aperture array structure is configured to be rotated about a particular rotation axis through a certain angle from a state where the principal surface thereof is perpendicular to a propagating direction of the electromagnetic wave and where at least one array direction of the two or more apertures is aligned with a polarizing direction of the electromagnetic wave.

9. An aperture array structure comprising a flat plate that includes at least two apertures penetrating therethrough in a direction perpendicular to a principal surface thereof, and has a lattice structure in which the at least two apertures are periodically arrayed at least in one direction along the principal surface, and a ratio (s/A) of a lattice spacing (s) of the aperture array structure to a thickness (A) of the specimen is 100 or less.

10. The aperture array structure according to claim 9, wherein the ratio (s/A) is 30 or less.

11. The aperture array structure according to claim 9, wherein the ratio (s/A) is 10 to 20.

12. The aperture array structure according to claim 9, wherein the lattice spacing (s) of the aperture array structure is 2600 μm or less.

13. The aperture array structure according to claim 9, wherein the at least two apertures of the aperture array structure are included in a square pattern.

14. A measuring device comprising:
an irradiation unit that applies an electromagnetic wave to an aperture array structure on which the specimen is held; and
a detection unit that detects the electromagnetic wave transmitted through the aperture array structure,
the measuring device measuring characteristics of the specimen from a frequency characteristic of the detected electromagnetic wave,
wherein the aperture array structure is a flat plate that includes at least two apertures that penetrate therethrough in a direction perpendicular to a principal surface thereof, and has a lattice structure in which the at least two apertures are periodically arrayed at least in one direction along the principal surface, and
a ratio (s/A) of a lattice spacing (s) of the aperture array structure to a thickness (A) of the specimen is 100 or less.

15. The measuring device according to claim 14, wherein the electromagnetic wave applied to the aperture array structure is a linearly polarized electromagnetic wave.

16. The measuring device according to claim 14, wherein the ratio (s/A) is 30 or less.

17. The measuring device according to claim 14, wherein the ratio (s/A) is 10 to 20.

18. The measuring device according to claim 14, wherein the lattice spacing (s) of the aperture array structure is 2600 μm or less.

19. The measuring device according to claim 14, wherein a frequency of the electromagnetic wave is 0.1 THz or more.

20. The measuring device according to claim 14, wherein the at least two apertures of the aperture array structure are included in a square pattern.
